(19) United States
(12) Patent Application Publication
(10) Pub. No.: US 2018/0006990 A1
(43) Pub. Date: Jan. 4, 2018

(54) EXCLUSIVE SOCIAL NETWORK BASED ON CONSUMPTION OF LUXURY GOODS

(71) Applicant: Jean Alexandera Munemann, London (GB)

(72) Inventor: Jean Alexandera Munemann, London (GB)

(21) Appl. No.: 15/198,828

(22) Filed: Jun. 30, 2016

(51) Int. Cl. H04L 12/58; G06Q 30/02; G06Q 50/00; H04L 29/08

(52) U.S. Cl. CPC H04L 51/32; G06Q 50/01; G06Q 30/0259; H04L 67/306

(57) ABSTRACT

Network node devices that may be embedded into luxury goods are described. These devices may allow luxury goods to offer access to a social networking system that is based upon ownership of luxury goods, and may also be used to verify the authenticity of the luxury goods. The devices may include an interface so that the device may communicate with other network node devices, including other products or a smartphone or other device, and a memory that stores a unique identifier of the brand or of the luxury good itself.

### FIELD OF THE INVENTION

The described technology generally relates to systems and devices for network-connected luxury goods. More specifically, the disclosure is directed to devices, systems, and methods related to goods which can be used to control access to exclusive social networks for owners of those goods.

### BACKGROUND

In traditional social networking applications, users may be connected based on a number of different criteria. However, it may be desired to maintain a social network and to create social connections between users of certain types of products. For example, it may be desired to create a social network in which users may leverage their ownership of certain products and items to meet others who own similar items. Accordingly, systems and devices that facilitate such a network may be desired.

### SUMMARY

The implementations disclosed herein each have several innovative aspects, no single one of which is solely responsible for the desirable attributes of the invention. Without limiting the scope, as expressed by the claims that follow, the more prominent features will be briefly disclosed here. After considering this discussion, one will understand how the features of the various implementations provide several advantages over current power receiving elements used in devices which can be charged wirelessly.

In one aspect, a network node device embedded in a product is described. The device includes a network interface configured to send messages and receive messages. The device further includes a memory, including storage for a brand identifier, wherein the brand identifier uniquely identifies a supplier of the product in which the network node device is embedded and user details, representing details of a user of the product. The device further includes a program memory, including storage for program code including program code for presenting a user interface for interaction with the network node device; program code to authenticate the network node device to the additional network node devices; program code for periodically querying a second device to determine if the product in which the network node device is embedded has been misplaced; and program code for interaction between the network node device and the additional network node devices if those devices are authenticated to having a brand identifier in common.

In one aspect, a networking device for use in a retail location is described. The device includes a processor and a network interface, usable to send and receive messages to and from network node devices embedded in products associated with the retail location. The device further includes a data memory, comprising storage for a brand identifier, wherein the brand identifier uniquely identifies a supplier of the products in which the network node devices are embedded; a retail location identifier; and a list of authorized network node devices that are within communication range of the networking device. The device also includes a program memory, comprising storage for program code including program code for identifying persons having one or more of the products based on their possession of products in which the network node devices are embedded and user identifying information that was provided to the network node devices; and program code for sending offers to users having the one or more of the products. The second device may include a server, or two or more other devices which operate using a block-chain or another ledger system. This system may be used to verify the identity of luxury goods, verify transactions involving luxury goods, and so on.

Another aspect of the present disclosure includes a method for operating a social network based on product ownership. The method includes detecting, in a mobile device, a network node device embedded in a product, the network node device including a brand identifier that uniquely identifies a supplier of the product in which the network node device is embedded and identifying the product based on the network node device including the brand identifier. The method further includes determining an owner of the product based on the network node device and based on an operator of the mobile device and storing user details including information about the owner of the product. The method also includes authenticating the mobile device to interact with other mobile devices based on the product including the brand identifier and providing communication capabilities between the mobile device and the other mobile devices through a social network, based on the product including the brand identifier.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 is an illustration of communications between various luxury goods which have electronic ownership tokens.

FIG. 2 is an illustration of a network node device according to some aspects of the present disclosure.

FIG. 3 is an illustration of a networking device according to some aspects of the present disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

In some aspects, a social networking system includes a server that receives messages from a user and distributes those messages to other users. These messages may be distributed to all other users, or may be distributed to only a subset of the other users. For example, the subset may be constructed based upon a user's choice of who to include in the subset, such as a group of friends. The subset of users may also be based on other factors, such as geographical factors, or based on common interests of those users. Messages which are posted by one user may be posted onto a message feed or another social networking mechanism.

Users in a social networking system may be able to communicate with one another in these ways. Different users may also be different types of individuals. For example, some users may include consumers, brand managers, and social network coordinators. Different types of users may have different abilities to interact with the social networking system. In some aspects, the social networking system maintains a database of users and a social graph connecting users to other users. These connections may be used to allow users to interact with one another, such as seeing the messages of the other users. These connections may be based upon user choice, or based upon other factors.

The database of users may also include data about the user that can be used to derive a status level in the social network. These status levels may contain information, from a number of different possible sources, about the status of every user in a network, and this information and status may be used to form connections between users who have similar statuses. In some aspects, these status levels may be thought of as clout scores.

In some aspects, access to the social networking system, or certain aspects of the social networking system, may be granted based on a status level of a user. For example, a user may gain access to certain functions of the social networking system based upon their own clout score. A consumer user may not be able to connect to other users, or certain other users, unless that consumer user has a sufficient status level. These status levels may be based upon a number of factors. One factor that a consumer user status level may be based on is ownership of luxury goods. For example, the social networking system may maintain a rule base that is used to determine status level given a user's particular details of luxury goods ownership.

In order for the social networking system to allow for status levels based on luxury good ownership, the system must be able to determine whether a user owns a particular luxury good. A number of different methods may be used to allow the system to determine a user's ownership of a luxury good. For example, a user's ownership of a given luxury good may be determined by detected presence of an electronic token embedded in the luxury good. For example, a product (such as a luxury good) may contain a token that enables to social networking system to determine that a user owns that particular luxury good.

The electronic ownership token may be a passive device, such as an RFID (radio frequency identification) tag, or an active device having a power source and computing ability. In some aspects, the electric token may be secured, such as in manners similar to the security provided in a number of other RFID tags or active devices. For example, the device may be configured using a unique identifier, and may be looked up in a database of known luxury goods based on the unique identifier. In some aspects, a user may be associated with a particular product when that product is purchased. For example, when an individual purchases a luxury product, the retailer may associate that user with the luxury product, and this association may be used by the social networking service.

In an example arrangement, manufacturers of luxury products embed a tag that can communicate wirelessly in each product they make. More generally, a supplier of products embeds a network node device in each instance of a product they make. The network node device might identify the supplier in general, the product (i.e., by SKU, model number, description, or the like), or a specific instance of the product (i.e., by serial number as well as supplier/product identifiers) in which it is embedded. The network node devices can communicate with other similar network node devices embedded in other instances of products as well as network node devices that are not embedded in instances of products, as might be the case with network node devices operated by a retail establishment. Retail establishment network node devices can communicate with network node devices that are embedded in instances of products that are present in or near the retail establishment.

A network node device can include memory and a processor, where the memory is used for storing a brand identifier that uniquely identifies a supplier of the product in which the network node device is embedded, product information, unique identifiers of the specific instance of the product and user details, representing details of a user associated with the specific instance of the product, which typically might be the current possessor and/or owner of the specific instance of the product. The network node device may include a program memory in which program code is stored, such as program code for presenting a user interface for interaction with the network node device, program code to authenticate the network node device to additional network node devices, program code for periodically querying a second device to determine if the product in which the network node device is embedded has been misplaced, and program code for interaction between the network node device and the additional network node devices if those devices are authenticated to having a brand identifier in common.

A specific instance of a product having therein an embedded network node device may have an associated user or associated possessor or associated owner. In many cases, the user, possessor and owner of the specific instance of a product is the same person, but that might not always be the case. For readability, “associated user” is used in examples where it should be understood that user, possessor and owner might be interchangeable.

The associated user might have a mobile device that the associated user has identified as being associated with a particular network node device, and that may allow communication to the associated user via the mobile device upon detection of the particular network node device. For example, with permission of the associated user, a wireless system at a retail establishment might detect the presence of a network node device and determine the telephone number of the mobile device that the associated user has identified as being associated with a particular network node device. This would allow the retailer to send a message to that associated user knowing that the associated user has the product. This would also allow for selective social media interactions to be based on whether the associated user has the product.

From time to time, individuals may sell or give away certain luxury goods. Accordingly, it may be desirable to, from time to time, verify continued possession of a particular luxury good by a particular user. The presence of the luxury good may be periodically checked to verify continued possession. A number of different methods may be used to verify the continued possession of a particular instance of a product.

For example, a verification process may user an owner's home Wi-Fi network (an IEEE 802.11-compatible network) which may communication with an electronic token in the good itself. In some aspects, a user's phone may communicate with the luxury good, such as using Wi-Fi or by using another technology, such as near-field communication with an RFID chip in the product. It may be desirable to verify possession of goods from time to time, such as perhaps every month or every few months. Limiting the number of needed verifications may allow for less power to be used, in the case where the products contain an active communications device which might otherwise consumer battery life, or another power source. Accordingly, the period between verifications, which may be referred to as a refresh period, may be measured in months.

Accordingly, in some aspects, the electronic ownership token embedded in a product may be configured to receive a request for an identity of a product, and to respond to this request. For example, this request may take the form of a packet transmitted using Wi-Fi or another wireless communication protocol. This may also be a request that is transmitted using a near-field technique, such as using an RFID token and using a magnetic field or another technique to determine an ID of the token. In some aspects, the response may include a packet that contains the ID of the token. For example, the ID of the token may be encrypted and transmitted in a Wi-Fi or other packet. In some aspects, the ID of the token may be looked up in a Brand Server database. The token may contain sufficient information for a receiving device to determine the brand and model of a given product.

Similarly, a user may sell a particular product to another individual and that individual may wish to show ownership of the product. For example, it may be desirable for a new owner of a luxury good to show ownership of this good in order to increase their social status on the social networking system, or in order to gain access to the social networking system. If a new owner of the luxury good seeks to register with the social networking system, a process may be done which might verify possession of the product. For example, a new owner might have an app on their smart phone which allows them to scan the product to show ownership of the product. This may allow the new owner to access to social networking system. The social networking system may also note that the old owner no longer owns the product, and the social networking system may update its database to reflect that the ownership of the luxury good has changed.

In some aspects, the social networking system may also be able to be aware of products that do not contain ownership tokens. These products may have been sold prior to the use of ownership tokens, for example. In some aspects, brand managers for a particular brand may be able to provide electronic tokens for luxury goods made by the brand prior to the use of built-in electronic ownership tokens. For example, an owner of a branded luxury handbag that was purchased fifty years ago might be registered so that the owner of such a unique bag could use that for their status level determination on the social networking system.

In some aspects, status level on the social networking system may be based on a number of different factors. For example, status level may be based in part on how many different luxury items a user owns. Status levels may also incorporate information about how a user purchased those goods. For example, differently status levels, or values, may be ascribed to a user who purchases a luxury good from an elite storefront versus from a discount shop, or to a user who purchases a luxury good new versus used. Status levels may also be based in part on how long a luxury good has been owned by an individual. For example, a group of luxury watch owners who have owned their watches for 30 years may be in a more exclusive status level than those who only recently purchased that brand of luxury watch. Accordingly, the social networking system may incorporate these differences into the system, and provide for different status levels, or different values of status, based on variations that include how many items a user owns, how the user purchased those items, and how long the user has owned those items, among other factors.

Such a social networking system may be useful to provide for certain users with similar tastes and status levels to connect with one another. The social networking system may be valued, at least in part, upon the exclusivity of membership in the system. Thus, since the social network system conveys membership access to certain groups within the social networking system, continued ownership and possession of the luxury goods may be required to maintain membership. Such continued ownership records may be maintained through the use of keys. For example, some users may manage a number of keys corresponding to goods that the user owns, through a smartphone app. The app may know the location of the smartphone and it may be configured to convey to the social network system the location of the user, which may be inferred from the location of the smartphone. Such location information may be controlled by a user, through the use of privacy settings. For example, the user may limit access to location information to a subset of other users, such as friends or only to nearby users, or may not allow any others to learn this information.

Further, an electronic ownership token or tag on a particular luxury good may also be customized. For example, this tag may be configured to be readable by others nearby based on a user's privacy settings. Thus, if two people are in close proximity to one another are both wearing a Brand B luxury coat with both users having the electronic ownership tokens set to broadcast their local presence, those used might be alerted to the nearby existence of each other. Such broadcasts may be used either using a token in the luxury good itself, or by using a user's smartphone or other device. Such broadcasts may facilitate interaction between two consumers of similar luxury goods, and may create an incentive to purchase official merchandise with brand-provided electronic ownership tokens. For example, the value provided by such a social networking system, including the ability to meet up with an interact with other similar owners, might incentivize a consumer to purchase one token-enabled luxury brand over another inferior brand, or may incentivize a consumer to purchase an authentic luxury good rather than an imitation or a counterfeit product.

Similarly, the use of electronic ownership tokens may also allow a consumer to recognize and identify authentic goods, and to avoid counterfeit goods. For example, the social networking system, or a smartphone app that is associated with such a system, may be configured to identify authentic goods. This may be especially valuable for consumers who are shopping for used items, and may not be able to otherwise determine if a luxury good is authentic.

Electronic ownership tokens provide information about the identity of an item, and may also provide information about the location of that item. This information may also be used in a number of other ways, in addition to the social networking aspects. For example, information on the identification, identity, and location system can be used to gather information which may be used for collateral for a loan, based on the official ownership and identified grouped location of items.

For example, item location verification may be obtained using a grouped interaction using a local IP address using an app or an RFID device configured to detect a number of different luxury goods in proximity to one another, and the identity of those devices. This information—that a consumer owns a number of luxury goods, each identifiable and locatable within a proximity of one another—may be used as collateral for a loan or for other purposes. Such a loan collateral system, based on the proximity of the items to one another, may be especially valuable to many consumers at it may allow a consumer to leverage personal luxury goods while maintaining possess of them, using an electronic or passive RFID system in the luxury goods, linked to the internet.

For example, the identification and branding described herein may be linked to a leverage system, which may enable consumers to raise money with their luxury items acting as assets for a loan. One way this might be done is if brands maintain item keys and ownership data for items from those brands. This data may then be used as collateral for loans or other financial instruments and transactions. Brands themselves may offer a leverage system to their customers, as a service, or may allow knowledge of ownership verification to be shared with third parties who may offer this service. Knowledge of the ownership of these luxury items, combined with knowledge of the secondary market value of the items, may be used to accurately assess the value of the luxury items and hence the true value of the assets available for leverage. For example, an individual, like Carrie in “Sex in the City”, might be able to leverage ownership of a large number of luxury items, like shoes, in order to obtain a down-payment on a condominium. Such leverage could be obtained even while an owner maintains possession of the items themselves, which may provide a great benefit to the owner. This leverage system may be used in conjunction with a database of the secondary market value of the goods themselves, such as data from the brands themselves, auction houses, and insurers.

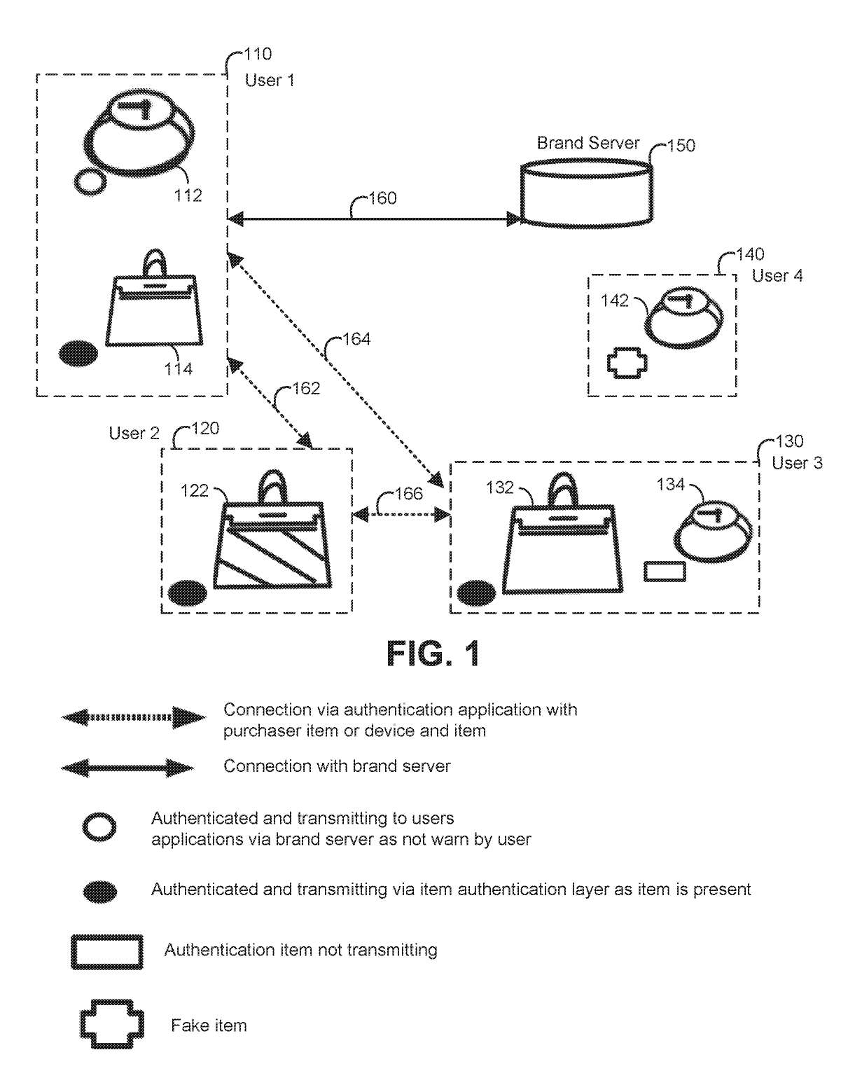

FIG. 1 is an illustration of communications between various luxury goods which have electronic ownership tokens. As illustrated, User 1 110 may own two luxury items, such as a watch 112 and a handbag 114. Both the watch 112 and the handbag 114 may be authentic items, and may be authenticated. For example, both items 112, 114 may contain electronic ownership tokens, and those tokens may both be registered on a server, such as the Brand Server 150. At a given time, User 1 110 may be using the handbag 114, but may not be wearing the watch 112. As illustrated, the handbag 114 of User 1 110 may be configured to communicate with other authentic items that are nearby. These communications may be either from the handbag 114 directly, or from another device, such as a smartphone that is carried by User 1 110 and is paired with the handbag 114 and the user's other items. The luxury items described herein may include a large number of different possible items. For example, while references are made to handbags and watches here, these luxury goods can also include a number of other items such as vehicles, artwork, clothing, jewelry, and other items. In some aspects, the luxury item itself may be made from e-fabrics or smart fabrics, such as Google's Project Jacquard, or a haptic feedback zebra fabric. This may enable interaction on the item itself, rather than using an app or other device, or in addition to using an app or other device.

In some aspects, the handbag 114 of User 1 110 may also communicate with the Brand Server 150. For example, both the handbag 114 and the watch 112 may be registered on the Brand Server 150. Thus, if User 1 110 has either the handbag 114 or the watch 112 present, that device may transmit to other devices the presence of User 1 110, so that other users may recognize User 1 110. This may happen in a number of ways. For example, the handbag 114 may advertise its presence to other products and users. These advertisements from the handbag 114, such as advertisements using an RFID device or using a transmitter inside the handbag 114 or a user's smartphone or other device, may include a unique identifier of the handbag 114. Based on this unique identifier, another device may look up the handbag 114, and determine that the handbag 114 is associated with User 1 110 on the social networking system. For example, the social networking system may include a number of different pieces of information about User 1 110, such as a name and a photograph or video of the user, as well as other types of information that may be included on a social media profile. In some aspects, certain portions of this information may also be transmitted by the handbag 114 directly. In some aspects, the handbag 114 may be configured to be queried, and may respond to a query from another device with unique identifying information, rather than advertising such information. For example, a nearby device may transmit a query to other devices in the area, and the handbag 114 may be configured to respond to the query and to identify itself.

Other users may also be near User 1 110 and may also have luxury goods capable of interacting with the social networking system. For example, User 2 120 may also by carrying a handbag 122 that includes an electronic ownership token. The handbag 122 of User 2 120 may be the same as the handbag 114 of User 1 110, or may be a different model or even a different brand, but may still contain an electronic ownership token and may still be configured to interact with the social networking system. For example, handbags from a variety of different luxury brands may be part of the social networking system, and may allow consumers with different types of luxury goods to connect with one another. In some aspect, the handbag 122 of User 2 120 may communicate directly with the handbag 112 of User 1 110. For example, these handbags 112, 122 may be able to identify each other, and to receiving a unique handbag identifier from the other bag. For example, these devices may communicate using wireless communications, such as using an RFID identification system or using a wireless communication system such as Wi-Fi or a cellular system. Users may interact with the social networking system using either the luxury goods themselves, such as through a user interface on a handbag 112, 122, or by using another type of device such as a smartphone. For example, a smartphone app may be provided which provides users with information about other nearby consumers, such as people with similar status levels, similar interest in consumer products, or other factors. Users may then be able to communicate with other users of the social networking system through their smartphone app.

User 3 130 may also be nearby, and User 3 130 may also have a handbag 132 that includes an electronic ownership token, and may also have a watch 134 that is an authentic item, but which is not transmitting. For example, this watch 134 may not include an electronic ownership token, or the watch may simply be configured not to transmit ownership to other users, such as based on a user selection. Items that contain such an electronic ownership token may allow users to turn off the activity of the token at any time. For example, an owner may wish to turn off the token at times which they do not wish to be discovered by other users, when they are carrying multiple luxury items with tokens, or when they wish to conserve battery life of a product.

The handbag 132 of User 3 130, as with the other handbags 112, 122, may include an electronic ownership token. This token may include an encrypted authentication layer which authenticates the handbag 132, and may combine with a key in a software application (such as a smartphone app) to produce an authentication signal which may be transmitted to the other handbags 112, 122. Alternatively, authentication may come from a Brand Server 150, if the purchaser does not have an item with them or if the item is not equipped with an electronic ownership token capable of communicating an encrypted authentication layer.

For example, the Brand Server 150 may be used to enable a smartphone app from one user to identify and authenticate another nearby user. A first user's smartphone app may transmit a signal, inquiring about the presence of other users nearby. The smartphone app may be configured to respond to this signal, such as responding in a manner which identifies a unique user on the social networking system. The first user's smartphone app may then query the Brand Server 150, to find out more information about the other users, and to authenticate the other users and the products that they own.

User 4 140 may also be near the other users 110, 120, 130. User 4 140 may be wearing a watch 142 as well, but this watch 142 may be a fake item, that is, not an authentic luxury watch. Because this watch 142 is a fake, it will be unable to communicate with the other devices. For example, the fake watch 142 will be unable to produce an authentication signal, because the fake watch 142 will not have any unique identifier associated with it, or if it does have such an identifier, the Brand Server 150 will be aware that the unique identifier is a fake, and not associated with an authentic luxury good that is part of the social networking system. In order to prevent such devices from becoming part of the social networking system, it is important to provide each authentic device with a way to authenticate other devices. For this purpose, each authentic device may be associated with a unique identifier, which that device may transmit, such as in an encrypted form, to other luxury goods. This identifier may be checked by those luxury goods, or using a smartphone app, in order to ensure that the luxury goods that are part of the social networking system are authentic. For example, the unique identifier may be checked either directly by the luxury good itself, or by a smartphone app, in communication with the Brand Server 150. The Brand Server 150 may thus verify the authenticity of various goods.

Accordingly, the social networking system may be useful for authenticating luxury goods, and for providing an exclusive venue for consumers of such goods to interact with each other. This may also provide additional value of consumers of luxury goods, and incentive for those individuals to continue to purchase and use authentic luxury goods, rather than using knock-offs, inexpensive brands, or fake items. This may be useful in regards to digital art, where the social consumption aspect and payment validation to an artist, with an edition number that is kept through the techniques described herein, may be important to the art work. Linking the proportional casting of a verification of payment to a brand or artists within a social setting, such as the use of a social networking app to verify and show ownership of digital and non-digital items, may be important.

As illustrated in FIG. 1, each of these communications may be between authentication applications and the Brand Server 150, rather than between the goods themselves. For example, each of the users may have a smartphone or another device. These devices may run an app which includes information on various luxury goods that the users own. This information may be authenticated using, for example, RFID chips built into the luxury goods and a Brand Server 150 that may authenticate those luxury goods. Based on this authentication, users may be assigned a status level of the social networking system. The smartphone app may be configured to alert a user when other users who have similar status levels are nearby, such as by playing a sound of showing a notification within the app. The smartphone app may also be configured to occasionally send out advertising messages, or otherwise inform other nearby smartphones running the same app that a user is nearby. These users may be connected to one another, depending upon their relative status levels and the types of luxury goods that they own.

Each of the communications in FIG. 1 is merely exemplary. For example, User 1 110 may have a handbag 114 which may communicate 160 with the Brand Server 150, such as to authenticate other devices or to find nearby devices. The handbag 114 may also communicate 162 with User 2 120 through handbag 122, and communicate 164 with User 3 130 through handbag 132. Similarly, handbag 122 may communicate with User 3 130 through handbag 132. Alternatively, these communications may be between a smartphone app (or other device) from each of these users with each other, rather than involving the handbags 114, 122, 132 themselves.

In some aspects, a given luxury brand may choose a type of authentication system, where more than one system may be available. For example, a brand may choose to include in one or more of their products a Wi-Fi connected processor. Alternatively, a brand may choose another automatic identification and data capture (AIDC) method, such as an RFID mechanism. Either of these two methods may be built into a luxury good, and may provide for a way to allow the luxury good to be uniquely identified and authenticated.

For example, a manufacturer may sync a uniquely identified processor or AIDC with requirements of that brand either before or after the uniquely identified processor or AIDC is inserted into a luxury good of that brand. This syncing may include associating the identifier, in the form of either uniquely identified processor or AIDC, with an authentication system, which might be part of such a social networking system. The authentication system may have an encrypted authentication layer with keys held by the brand itself. This layer may provide for authentication that the item is an authentic branded item. The authentication system may further have a purchaser interaction layer which controls public transmission of item details.

The item authentication layer may be configured to contain a unique identification for a given item. Each item's identification may include or describe the brand identity of the item, a serial number of the item, an authentication identification code in order to authenticate the item, and any further brand details desired. For example, other brand details might include a name of the crafts persons who created the item, the materials that were used to construct the item, details of loyalty points associated with the item, and so on.

In some aspects, the various data described above may be contained on the processor or AIDC in an encrypted form. This encryption may use the authentication layer and interaction layer keys, which may be held by the brand. Accordingly, this information may be accessible only using a Brand Server 150.

When a user purchases the item, the user may be given keys to the interaction layer. That is, the user may be allowed to control the interaction layer of the device, such that the user may be able to selectively transmit brand authentication, personal data linked to the item such as location or price of purchase, or may shut down any item transmission. Accordingly, the user may be able to control whether or not the item may transmit such information, and accordingly control the user's availability or non-availability on the social networking system.

In some aspects, an item may contain both the authentication mechanism, such as a processor or an AIDC, and the user interface. Alternatively, the item may contain the authentication mechanism, but the user interface may be in another device. Authentication may be transmitted via the item directly, the item and a synced device such as a smartphone, the item, a synced device and the Brand Server 150, or a synced device and the Brand Server 150.

Generally, an encrypted authentication layer combines with the key in the user application layer to produce the authentication signal item itself. Additionally, the authentication can come from the Brand Server 150 if the purchaser doesn't have the item with them. Alternatively, the branded item may be constantly transmitting its authenticity, when a device such as a RFID is used instead of a processor, and any receiving device may compare the signal with the Brand Server 150.

In some aspects, a user may be able to log in to the authentication application (such as on a smartphone app or a computer) to adjust transmission and privacy settings.

The full privacy settings may allow a user to choose which degree of separation to transmit or receive information, or which group or profession they will transmit their brand affiliation to. In this instance a group can mean a group of customers of a brand that have reached a certain hierarchical level with in the brand affiliation structure. For example, a user may alter their privacy settings to share more or less information with various people based on a group affiliation.

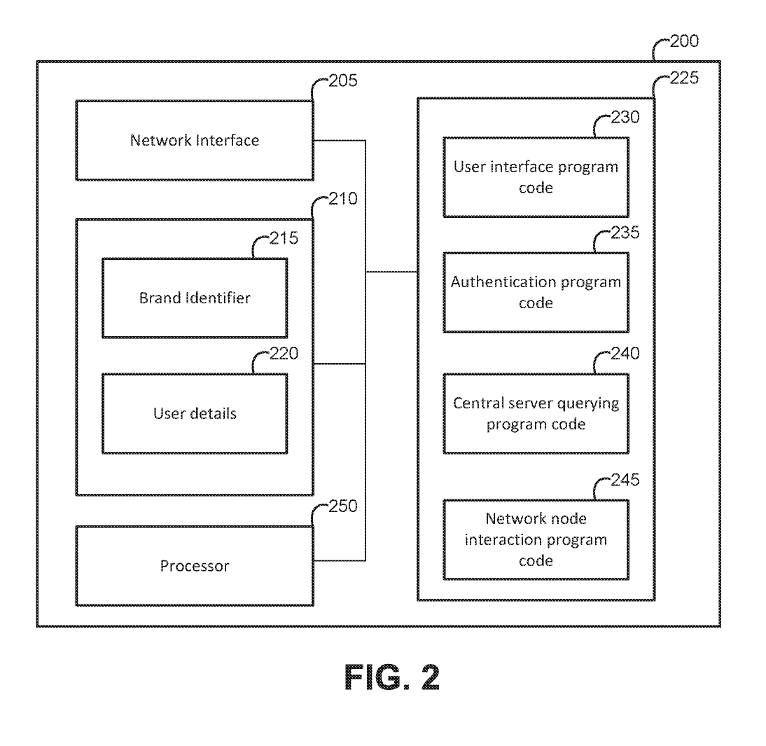

FIG. 2 is an illustration of a network node device 200 according to some aspects of the present disclosure. The network node device 200 may be embedded into a product, such as being embedded by the manufacturer in a luxury good, such as a handbag or a watch.

The network node device 200 includes a network interface 205 configured to send and receive messages. For example, the network interface 205 may be configured to transmit packets using a wireless communication network. The network interface 205 may include a transmitter and a receiver, which may be combined into a transceiver configured for use with a wireless communications network. The network interface 205 may be configured to transmit messages to and from similarly-equipped network node devices, and/or to transmit messages to and receiver messages from a Brand Server 150, as illustrated in FIG. 1. The network interface 205 may be a wireless network interface and the power source for the network interface 205 may be a battery, such as a rechargeable battery using lithium-ion or other technology.

The network node device 200 further includes a memory 210 that is operably connected to the network interface 205. This memory 210 may be a volatile memory, such as a random access memory, or a non-volatile memory. This memory 210 may be a hard drive, or may include flash memory or other memory modules. The memory 210 may include a brand identifier 215, which uniquely identifies a supplier of the product in which the network node device 200 is embedded. The brand identifier 215 may also identify the specific product that the network node device 200 is embedded in, such as a model of the product and a unique product identifier.

The memory 210 may also include user details 220 which represent details of a user of the product. For example, the user details 220 may include information about the user on the social networking system. This information may include the user's social networking system profile, or a link to that profile. For example, the user details 220 may include a unique identifier configured to uniquely identify a user to look up further information. This identifier may be a number or another identifier, associated with a particular user and/or a particular network node device. Such an identifier may be used by another device in order to find out more information about a particular user. For example, the identifier may be a URL or another link to a user's profile information on a social networking system. Accordingly, the user details 220 may include details about a user that are stored locally and/or may include a link or identifier which may be used to find additional user details. The user details 220 may be configured by a retailer when selling an item, or may be set up in another manner.

The network node device 200 further includes a program memory 225 which provides storage for program code. The program memory 225 includes program code for presenting a user interface for interaction with the network node device (user interface program code 230), program code to authenticate the network node device to the additional network node devices (authentication program code 235), program code for periodically querying a central server to determine if the product in which the network node device is embedded has been misplaced (central server querying program code 240), and program code for interaction between the network node device and the additional network node devices if those devices are authenticated to having a brand identifier in common (network node program code 245).

In some aspects, the user interface program code 230 may include a web server interface. For example, a luxury good may provide a user interface in the form of an internet site that a user may access to add, update, edit, or remove their information. Accordingly, in order to present such a user interface to an end user the network node device may include user interface program code 230 that is a web server interface, in order to allow a user to access such an internet site to update their own personal information, such as the user details 220 stored on the network node device 200. In some aspects, the user interface program code 230 may include program code for receiving input from a user transmitted using a mobile device. For example, the user interface program code 230 may be configured to receive input from a user who uses an app on a mobile device such as a smartphone or a tablet. These apps may be configured to communicate with the user interface program code 230 on the network node device 200.

The network node device 200 further includes a processor 250 operably connected to the program memory 225 and the memory 210. The processor 250 may be configured to execute the program code included in the program memory 225, and to transmit and receive using the network interface 205. In some aspects, the illustrated aspects of the network node device 200 may be combined with each other, or their functions may be performed by two or more different portions of the device 200. For example, it may be possible to combine the memory 210 and the program memory 225 into a single memory, such as using flash memory or another type of storage. Similarly, it may be possible to combine the brand identifier 215 and the user details 220 into a single portion, such as a unique item identifier that may be used to uniquely identify both the brand of the product and the user of the product in which the network node device 200 is embedded.

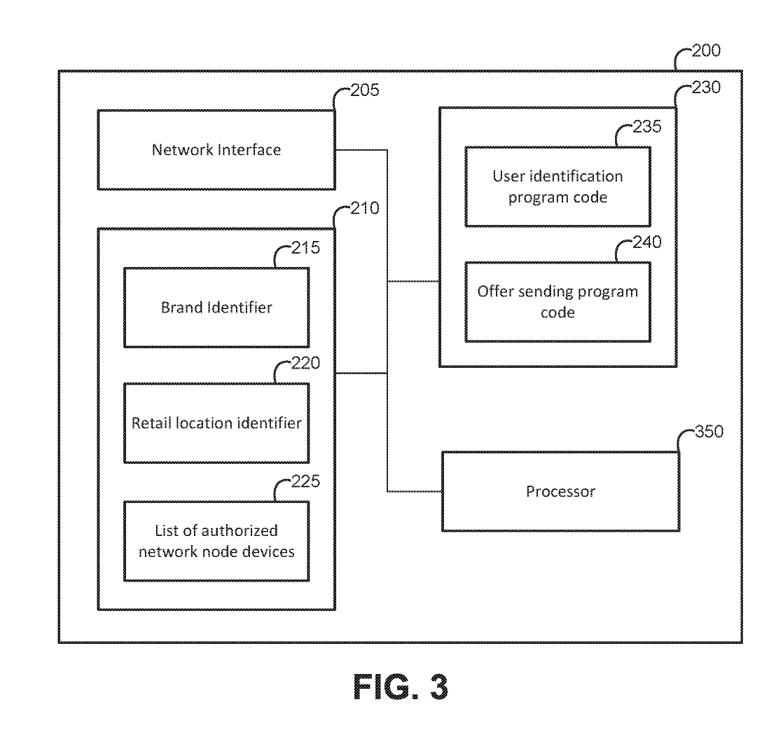

FIG. 3 is an exemplary illustration of a networking device 300 for use in a retail location according to some aspects of the present disclosure. The networking device 300 may be used to provide information to a network node device 200, when that device is sold.

The networking device 300 may include a processor 350. This may be a general-purpose processor, or one or more chips working together to operate as processor 350. The networking device 300 also includes a network interface 305. The network interface 305 may be usable to send and receive messages to and from network node devices embedded in products associated with the retail location. For example, the network interface 305 may include a transmitter and a receiver, or a transceiver, configured to operate on a wireless communications network, such as a Wi-Fi or other network. The network interface 305 may be configured to transmit messages to network node devices embedded in products, such as when those products are being sold. For example, the network interface 305 may be configured to inform a network node device of where that product was sold, and to information the network node device of the new owner of the product.

The networking device 300 may also include a data memory 210, which includes storage for a brand identifier 215. The brand identifier 215 uniquely identifies a supplier of the products in which the network node devices are embedded. The data memory 210 also includes a retail location identifier 220, which identifies the retail location itself. For example, this may identify a certain store, or may identify the store as a type of store, such as a high-end boutique. The data memory 210 also includes a list of authorized network node devices 225 that are within communication range of the networking device. For example, the list of authorized network node devices 225 may include the devices found in products sold in the store. The list of authorized network node devices 225 may be used to configure those devices, such as enabling those devices to be instructed when they are sold and to whom they are sold. The list of authorized network node devices 225 may also be used for other purposes, such as for inventory purposes in the retail location.

The networking device 300 may also include a program memory 230. The program memory 230 may include user identification program code 235, such as program code for identifying persons having one or more of the products based on their possession of products in which the network node devices are embedded and user identifying information that was provided to the network node devices. For example, this program code may be used, in connection with the network interface 205, to identify nearby products that have a network node device. This may be done in a number of ways. For example, the networking device 300 may periodically transmit a request on a wireless channel known to the network node devices, requesting that those devices respond on the same channel. Accordingly, those devices may respond, and therefore the networking device 300 may be configured to identify the responding devices.

In one aspect, the user identification program code 235 may request information from nearby devices, such as by broadcasting a request on a wireless communications channel. A network node device may be configured to respond to this request with a transmission on the same channel. This response may identify the network node device and/or the user of the network node device. This response may merely identify the network node device itself, in which case, the user identification program code 235 may be configured to request additional information on the user of the responding network node device. This information may be requested from the network node device itself, or from another source, such as from a centralized social networking system server, such as the brand server 150 in FIG. 1. In another instance, the user identifying information might be used as an index to look up additional user information.

The program memory 230 may also include program code for sending offers to users having the one or more of the products 240. For example, the networking device 300 may be configured to periodically transmit offers to certain users. These offers may alert users of sales or of other deals that may be of interest to those users. For example, the networking device 300 may transmit offers to users who have previously purchased products from the retail location, using the connection between the networking device 300 and the network node devices embedded in the products that were previously sold. These offers may be transmitted directly to the network node devices, such as when the products are within the retail location, or may be transmitted using the Internet to the network node devices.

Authentication of a specific instance of a device might occur with a network node device communicating with a central registry server. In such cases, the network node might receive a token usable for communicating with other network nodes so convey to those other network nodes some authorization to represent that instance of a product. The authentication of a specific instance of a device might occur using a distributed ledger, such as a block-chain ledger, wherein each time there is a transfer of the specific instance of a product, such as a sale or gifting of the specific instance, the network node device records a transaction on the ledger to that effect. Where a person can authenticate that they are the final link in the transactions related to that specific instance of a network node device (by proxy of the specific instance of the product), that person thereby authenticates the network node device.

In some aspects, the device may also use decentralized authentication. For example, an app may use a block-chain ledger, and the brand at a point of sale may give the user “coins” and “keys” which are then linked with the buyer and provide information about the item and its ownership. For example, this approach may be used to show ownership of a given luxury good in a decentralized manner, similar to the approach used in bitcoins and other decentralized currencies. After receiving an initial authorization, an app may then use mesh, Bluetooth, location notifications, or other active routing which goes via the app linking the item and user identification and the local IP address in order to register it on the decentralized network. This network may work with any standard dynamic peer-to-peer routing system. In some aspects, the system may be designed to balance a users' personal data consumption as well. A lead hierarchical device may maintain the block-chain ledger, and send the validation request to dependent synced user devices or items, so that the data usage by dependent devices or items is minimized.

In this technique, when a user wishes to sell an item, the item's ledger grows like a bitcoin system. Each brand may maintain their own ledger, and an app may sort out the relevant ledgers to translate the possible social notifications. Such a decentralized system may become more advantageous as devices become ever more powerful, or may be used as a hybrid system with a centralized technique as well. In some aspects, brands may also use block-chain to manage the data and maintain central servers as well.

In some aspects, an authentication system for luxury goods may also deter theft. For example, if thieves remove the RFID or other identifying social network hardware from an item, the brands and social network will not recognize an item without the legitimate keys. Accordingly, if an item is authentic, but stole, the item may lose some of its holistic value, due to its lack of social networking feature. Similarly, a stolen item that does not have its identifying features removed maybe used to track the item, which may benefit law enforcement in location the item. Similarly, if an item is not purchased properly, registered, and linked to the social network at the point of sale, it may be configured to send out push notifications that any open app or device could hear. This may be used to notify the relevant authorities that the device has been stolen.

A user may also “lock” the item to a static or group IP address (or phone or other device), and link items in a group of items. The user may “unlock” specific items when they go out, so if the item leaves the set area and is unable to be pinged, the user or relevant authority would be notified appropriately, such as after a period of time. This security aspect may be beneficial in a number of ways, and may result in reduced insurance premiums, as the item may be much more security and less likely to be stolen than other items without these security features.

The social network described herein may also allow different augmented reality or virtual reality overlays. For example, these overlays may be placed onto real life luxury items, depending upon a user's settings. For example, a branded item might contain “hidden” details with visibility only accessible via the social network verification.

In some aspects, a device on a luxury item, such as an RFID or NFC device, may be used in a virtual or augmented reality overlay which might be worn by users, such as glasses, contacts, head sets, and so on. The itemized social network may have such an identification device in a luxury good, which is seen by normal eyes as just a standard luxury good of its type. However, with an augmented reality or virtual reality headset, the luxury good may appear differently depending upon a user's level within the social network. The owner of the item and the brand, or artist, may set a visibility level of a virtual overlay on the item, which is available to other users. For example, a user may select an artist, such as Tracy Emin, to virtually personalize an item. Thus, an item may gain value due to the personalization as well as the original item itself, but for both social and safety reasons, it may be advantageous for a user to not show that personalization in certain situations, or a user may only want to show the personalization to certain individuals. Thus, the personalization may be done in an augmented reality or virtual reality system, which may allow a user to control who can and cannot see the personalization. This may be an example of the “hierarchical stealth boasting” capabilities of such a social networking system. Such a system may enable virtual collectible items or personalizations by artists which are visible only through the hidden hierarchy, through a hierarchy app.

In some aspects, a system for operating an authentication network based on product ownership is disclosed. The system may include an electronic identifier embedded in a product. The electronic identifier may be an active identifier, such as an identifier equipped with an ability to wirelessly transmit information using electromagnetic waves, or a passive identifier such as an RFID device. The system includes a device synced with the electronic identifier in the product, where the device includes a network interface configured to send messages and receive messages and a memory, which has storage for an identifier that uniquely identifies the product and user details that represent details of an owner or user of the product. The device may include, for example, a mobile device such as a mobile phone or tablet which is operating an app, such as a social networking app. The app may have access to identifiers of products that the user owns, such as the electronic identifier, as well as other products a user may own. For example, the identifier may indicate a brand, model, serial number, and other information about the product. The user details may include a number of details about a user's access to a social network, such as a unique user identifier and may include other user information about the user as well.

The device further includes a program memory, including storage for program code configured to present a user interface for interaction with the device, authenticate the identifiers held by device to a plurality of other devices, update change of product ownership between the device and another device of the plurality of other devices, and interact with one or more devices of the plurality of other devices on the condition that the one or more devices are authenticated as having the identifier that uniquely identifies the product. For example, the user interface may be similar to that of a social networking program or other application, allowing a user to interact with other users. The program may be configured to identify itself to other users based on a variety of factors, such as shared ownership of the same or similar products, group of products, history of ownership of products, history of the product, place of purchase of products, proximity between users and patterns of proximity between users or devices. Further, though a person may no longer own a particular product, the program may be configured to assign a value to previous product ownership and the duration of ownership of such a product. Additionally, if the product was previously owned by a celebrity, the product may have greater value to some people and the program may incorporate this value when determining whether to identify itself to another device. Proximity matters might include determining when and how often a person is at a particular location, such as a gallery, a night spot, a restaurant, a hotel, a travel destination, or an airport. This information may be used to show the type of lifestyle that the person maintains. The program may be configured to compare this lifestyle to that of others, and the greater the synchronicity between the lifestyles, or points of commonality with another user of the program, the greater the indication they would be more open to a mutually beneficial introduction via the program.

The program may be configured to identify itself to other users based on a variety of factors, such as proximity patterns or current proximity, and shared ownership of the same or similar products. For example, two owners of luxury handbags may be able to “see” each other on the social network based on similar ownership patterns and based on proximity to one another. The program memory may also allow for changes of ownership between one owner (with one device) and another owner (who has another device). This may allow a user to sell their goods to others, who can then access the social network based on their ownership of the prestigious item. Finally, the program memory may allow interaction between devices which are authenticated as having the given identifier. For example, each owner a particular product may be able to interact with one another using the program. The program may also include code to allow the program to interact with a second networking program (such as another social network including Instagram) to authenticate the validity of the identified item and ownership history, and provide the user a mark of validation for use in the second network.

In some aspects, the device includes storage for a plurality of identifiers that uniquely identify a plurality of products. For example, a given user may own a large number of different goods, each of which may be registered in the device and used to adjust a credit level for the user based on the uniquely identified plurality of products. This credit might take the form of, for example, a score for a given user, in one or more difference categories. For example, higher tiers of credit may have access to more elite social networks, and to other users with similarly high tiers of credit. The program may be set so only the person with the higher value or cumulative higher value of unique items allows contact in a given interaction between two users. In some aspects, the user may gain a credit for sharing the identifier with the plurality of other devices. For example, a user may be able to share a name and model of various luxury goods that that user owns, and this may be used to increase a credit to that users' account. In some aspects, this credit may take the form of a score of some sort, or users may be recompensed monetarily for sharing such information. In some aspects, the device includes program memory with program code configured to transmit a link to purchase the product to another device of the plurality of other devices. For example, the link may be a URL transmitted to another user to purchase the item through a retail channel. The link may allow for a user to be paid when another person follows the link and purchases the item. For example, a particular user may have an attractive luxury product. Another user may see that good, and use the program to find out what brand and model the luxury good is, and then be able to click a link to purchase the luxury good. When another user clicks a link provided by the first user, the first user may be recompensed as a “brand ambassador” of sorts. This may allow for an incentive for owners of prestigious goods to use the social network, and allow other users to easily find out information about attractive items they might see others carrying or using.

The program may also have code to offer users privacy settings. This code may allow users to allow or disallow information sharing or contact between different levels of social contacts. For example a user may not wish to share any personal data beyond four levels of social separation, beyond 5% divergence of item ownership, but may wish to share with all users, brand advocate details of what they are currently wearing. Accordingly, the privacy settings may enable a user to alter how much information is shared about what they own, what they are wearing, and their personal details with various levels of separation from the social network, and with the network as a whole.

The program may also have code to use the device functionality to intermittently broadcast its current location via proximity or geolocation notifications to other devices, allowing users of the network to locally view one another, subject to privacy and other user settings. The device may also have code to respond to requests for identification by other local authorized devices.

For example, a first user may wish to gain social or monetary currency by being a brand advocate, allowing their device to catalogue the items the user is currently using or wearing via item identifiers, thus allowing purchase by nearby second users. The first user may provide purchase links to brand items, where the links are viewable to all other users, but may only allow personal contact information to other users with a specified level of social currency or item ownership, in order to maintain privacy. The first user may also allow their list of identifiers or a portion of the identifiers to be viewed, and the user may maintain a list of “wanted” items. This may allow a second user to “save” the item to their “wanted” list or to purchase the item directly using a product link. When the second user “saves” or purchases the item, the first user may gain a social or monetary credit. If a user has previously saved an item, but purchases the item after viewing it on another user, credit may be split among the various users who have been involved in “advocating” that item. Additionally, the program may allow credit to be proportioned via a number of different users when another user purchases the product, based on the purchasing user's various interactions with owners of the product. The program may also allow credit to be given to the various brand advocates for subsequent re-sellers.

The program may also have code to allow the users to exchange, sell, or barter various identified items that they own. For example, the first user with a “wanted” identified item may allow links to show a number of similar subsequent identified items from a variety of other users for sale, resale, or barter within the network. Thus, a user wishing to purchase may choose to purchase from one of the variety of different sellers for a variety of reasons, such as a barter score credit they might accrue for completing a transaction, who they are, or what degree of separation they might be from the purchasing user.

In another example a user may wish to only date or befriend other local users with certain types of identifiers, or identifiers and proximity patterns. Thus, a user may set parameters for which other devices that user may be exposed to, based on proximity patterns and common item ownership, or item ownership within certain classes or tiers. In another example, an authorized 3-D printed or virtual art work with a legitimate identifier may locally broadcast its authenticity via a synced device, enabling a first user to alert subsequent users that they are supporting the artist, and subsequently allowing other users to purchase that artwork legitimately and with assurances that their purchase is of an authentic item and will help support the artist.

The program may also have code to allow for a neural network based on semi-supervised learning of user patterns. This neural network may make suggestions to users, such as suggesting other users for friendship or dating, suggesting items the user may wish to purchase, or suggesting places the user may wish to visit.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A network node device comprising:
a network interface configured to send messages and receive messages;
a memory, comprising storage for:
a brand identifier that uniquely identifies a supplier of the product in which the network node device is embedded; and
user details, representing details of a user of the product; and
a program memory, comprising storage for program code including:
program code to authenticate the network node device to additional network node devices; and
program code for interaction between the network node device and the additional network node devices if those additional network node devices are authenticated as having a brand identifier in common.

2. The device of claim 1, wherein the network interface is usable to send and receive messages between the network node device and the additional network node devices in other instances of products and between the network node device and a retail establishment network node device associated with a retail location.

3. The device of claim 1, wherein the network interface is a wireless network interface.

4. The device of claim 1, wherein the network interface is a transceiver configured for use with a wireless communications network.

5. The device of claim 1, wherein the program code for presenting a user interface for interaction with the network node device comprises a web server interface.

6. The device of claim 1, wherein the program code for presenting a user interface for interaction with the network node device comprises program code for receiving input from a mobile device.

7. The device of claim 1, wherein the brand identifier further identifies a specific instance of a product in which the network node device is embedded.

8. The device of claim 1, wherein the user details include a unique identifier that uniquely identifies the user and is usable as an index for looking up additional information about the user.

9. The device of claim 1, wherein the second device is a server.

10. The device of claim 1, wherein the second device is two or more second devices that use a block-chain or other ledger system.

11. The device of claim 1, wherein program memory further comprises storage for program code for presenting a user interface for interaction with the network node device.

12. The device of claim 1, wherein program memory further comprises storage for program code for program code for periodically querying a second device to determine if the product in which the network node device is embedded has been misplaced.

13. A networking device for use in a retail location, comprising:
a processor;
a network interface, usable to send and receive messages to and from network node devices embedded in products associated with the retail location;
a data memory, comprising storage for:
a brand identifier that uniquely identifies a supplier of the products in which the network node devices are embedded;
a retail location identifier; and
a list of authorized network node devices that are within communication range of the networking device; and
a program memory, comprising storage for program code including:
program code for identifying persons having one or more of the products based on their possession of products in which the network node devices are embedded and user identifying information that was provided to the network node devices; and
program code for sending offers to users having the one or more of the products.

14. The device of claim 13, wherein the network interface is a wireless network interface.

15. The device of claim 13, wherein the network interface is a transceiver configured for use with a wireless communications network.

16. A method for operating a social network based on product ownership, the method comprising:
detecting, using a mobile device having an associated user, a network node device embedded in a product, the network node device including a brand identifier that uniquely identifies a supplier of the product;
identifying the product based on the brand identifier included in the network node device;
determining an owner of the product based on the associated user of the mobile device;
storing user details of the associated user, including information about the owner of the product;
authenticating the mobile device for interaction with other mobile devices based on the brand identifier; and
providing communication capabilities between the mobile device and the other mobile devices through a social network, based on the brand identifier.

17. A system for operating an authentication network based on product ownership, the system comprising:
an electronic identifier embedded in a product;
a device synced with the electronic identifier in the product, the device comprising:
a network interface configured to send messages and receive messages;
a memory, comprising storage for:
an identifier that uniquely identifies the product;
user details that represent details of an owner of the product;
a program memory, comprising storage for program code configured to:
present a user interface for interaction with the device;
authenticate the device to a plurality of other devices;
update change of product ownership between the device and another device of the plurality of other devices; and
interact with one or more devices of the plurality of other devices on the condition that the one or more devices are authenticated as having the identifier that uniquely identified the product.

18. The system of claim 17, wherein the device has memory including storage for a plurality of identifiers that uniquely identify a plurality of products.

19. The system of claim 18, wherein the device has program memory including storage for program code configured to adjust a credit level for the user based on the uniquely identified plurality of products.

20. The system of claim 17, wherein the user gains a credit for sharing the identifier with the plurality of other devices.

21. The system of claim 20, wherein the device includes program memory with program code configured to transmit a link to purchase the product to another device of the plurality of other devices.
